(19) United States
(12) Patent Application Publication
(10) Pub. No.: US 2012/0106056 A1
(43) Pub. Date: May 3, 2012

(54) COMPUTER MOUSE

(75) Inventors: TSUNG-SHIH LEE, Tu Cheng (TW); Yu-hsiang Ting, Tu-Cheng (TW)

(73) Assignee: Cheng Uei Precision Industry Co., LTD., Tu Cheng City (TW)

(21) Appl. No.: 12/916,578

(22) Filed: Oct. 31, 2010

(51) Int. Cl. G06F 1/16

(52) U.S. Cl. 361/679.4

(57) ABSTRACT

A computer mouse is provided, and has a mouse main body, a rubber cover and a foot pad. The mouse main body has at least one engagement hole. The rubber cover is covered on an outer side of the mouse main body and formed with at least one opening corresponding to the engagement hole. The foot pad has a flat foot-pad main body which has at least one engagement member. The engagement member has an elastic arm and an engagement fastener protruded from a distal end of the elastic arm. The engagement member passes through the opening, and then engaged and received in the engagement hole. When installing the computer mouse, the engagement fastener can be engaged and received in the engagement hole, so that the foot pad is firmly mounted on the computer mouse. Thus, the computer mouse has simpler installation and aesthetic appearance.

### FIELD OF THE INVENTION

The present invention relates to a computer mouse.

### BACKGROUND OF THE INVENTION

Traditionally, when a computer mouse is used to move on an object (such as a desk top, a mouse pad and etc.), the friction is inevitably and continuously generated between the computer mouse and the object. For increasing the abrasion resistance of a traditional computer mouse, at least one foot pad is generally attached to a bottom end surface of the computer mouse by adhesive or screw-connected thereto by screws.

However, the foot pad of the traditional computer mouse is installed by adhesive or screws, so that the installation is relatively complicated and has no aesthetic appearance.

### SUMMARY OF THE INVENTION

A primary object of the present invention is to provide a computer mouse, which has simpler installation and aesthetic appearance and thus can overcome the disadvantages existing in the conventional technologies, as described above.

To achieve the above object, a computer mouse of the present invention comprises a mouse main body, a rubber cover and a foot pad. One end of the mouse main body has at least one engagement hole. The rubber cover is covered on an outer side of the mouse main body and formed with at least one opening corresponding to the engagement hole of the mouse main body. The foot pad has a flat foot-pad main body which has one end formed with at least one engagement member. The engagement member has an elastic arm and an engagement fastener protruded from a distal end of the elastic arm. The engagement member passes through the opening of the rubber cover, and then engaged and received in the engagement hole.

As described above, when installing the computer mouse of the present invention, the engagement fastener of the foot pad can be engaged and received in the engagement hole of the mouse main body, so that the foot pad is firmly mounted on an outer side of the computer mouse. Thus, the computer mouse has simpler installation and aesthetic appearance.

### DESCRIPTION OF THE DRAWINGS

FIG. 1 is an exploded perspective view of a computer mouse according to a preferred embodiment of the present invention;

FIG. 2 is a perspective view of a foot pad as shown in FIG. 1 from another viewing angle;

FIG. 3 is a partially cross-sectional view of the computer mouse according to the preferred embodiment of the present invention; and

FIG. 4 is a partially enlarged view of a portion “I” as shown in FIG. 3.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

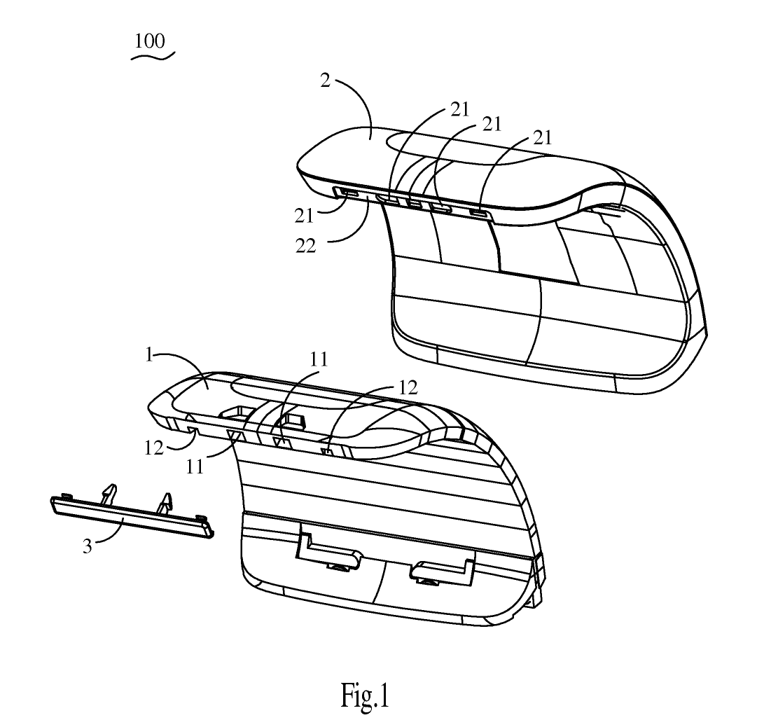

Referring now to FIG. 1, a computer mouse 100 according to a preferred embodiment of the present invention is illustrated. As shown, the computer mouse 100 has a specific L-shape curved profile, and comprises a mouse main body 1, a rubber cover 2 and a foot pad 3.

Referring still to FIG. 1, one end of the mouse main body 1 has at least one engagement hole which includes a first engagement hole 11 and a second engagement hole 12. In the embodiment, the engagement hole includes two first engagement holes 11 and two second engagement holes 12, wherein the two first engagement holes 11 are formed on a central portion of the end of the mouse main body 1, while the two second engagement holes 12 are formed on two outer sides adjacent to the central portion.

The rubber cover 2 has a profile matched with that of the mouse main body 1. The rubber cover 2 is formed with a plurality of openings 21 corresponding to the engagement holes of the mouse main body 1. One end of the rubber cover 2 having the openings 21 is further provided with a receiving recess 22.

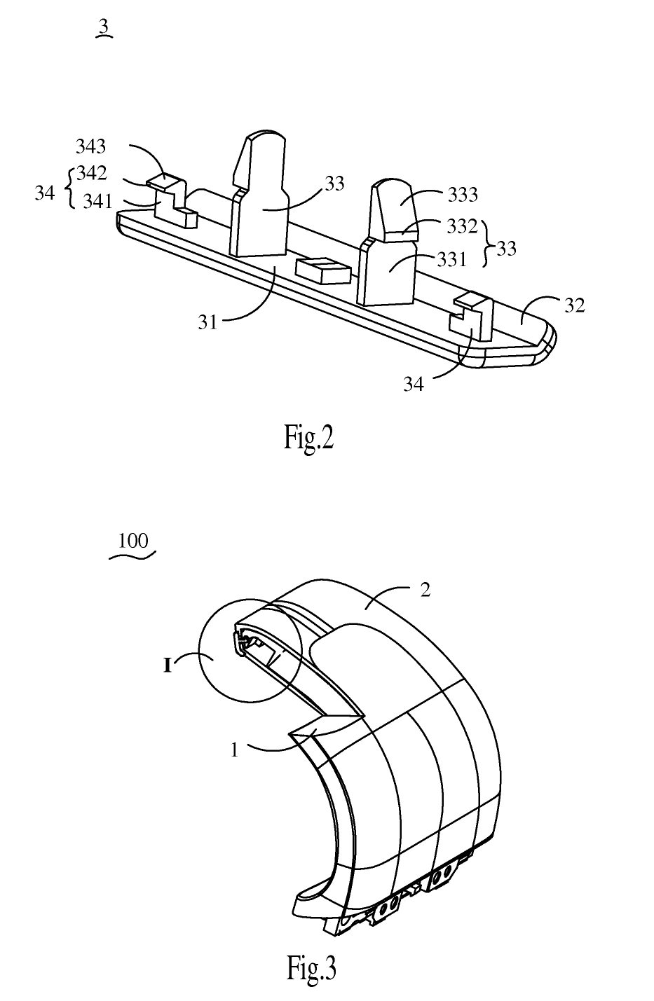

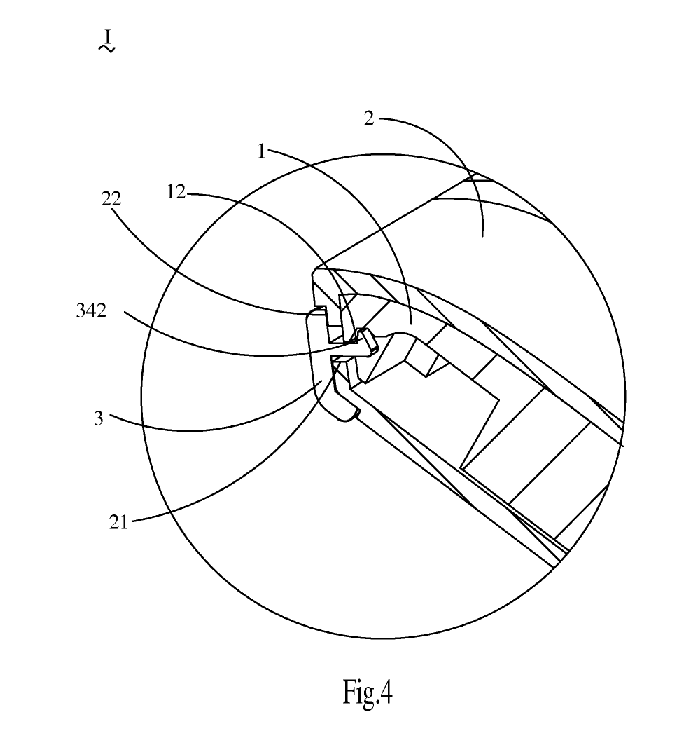

Referring now to FIGS. 1, 2, 3 and 4, the foot pad 3 has a flat foot-pad main body 31, wherein the foot-pad main body 31 has one side edge extended to form an inclined holding portion 32, while the foot-pad main body 31 further has one end formed with at least one engagement member corresponding to the engagement holes of the mouse main body 1. The engagement member includes two first engagement members 33 and two second engagement members 34. The first engagement members 33 are formed on first positions of the foot-pad main body 31 corresponding to the first engagement holes 11 of the mouse main body 1, wherein the first engagement members 33 has a first elastic arm 331 connected to the foot-pad main body 31 and a first engagement fastener 332 protruded from a distal end of the first elastic arm 331. The first engagement fastener 332 of the first engagement member 33 further has a first inclined guiding surface 333. Furthermore, the second engagement members 34 are formed on second positions of the foot-pad main body 31 corresponding to the second engagement holes 12 of the mouse main body 1, wherein the second engagement members 34 has a second elastic arm 341 connected to the foot-pad main body 31 and a second engagement fastener 342 protruded from a distal end of the second elastic arm 341. The second engagement fastener 342 of the second engagement members 34 further has a second inclined guiding surface 343.

When installing the computer mouse 100 of the present invention, the rubber cover 2 is covered on an outer side of the mouse main body 1 for increasing the aesthetic effect and the operational comfortableness of the computer mouse 100. The foot-pad main body 31 of the foot pad 3 is received in the receiving recess 22 of the rubber cover 2. The holding portion 32 of the foot pad 3 can engage against an outer side of the rubber cover 2. The first inclined guiding surfaces 333 guide the first engagement members 33 to pass through the openings 21 of the rubber cover 2. The first elastic arms 331 of the first engagement members 33 are received in the first engagement holes 11, while the first engagement fasteners 332 engage against an inner edge of the first engagement holes 11 facing two lateral sides of the rubber cover 2. Moreover, the second inclined guiding surfaces 343 guide the second engagement members 34 to pass through the openings 21 of the rubber cover 2. The second elastic arms 341 of the second engagement members 34 are received in the second engagement holes 12, while the second engagement fasteners 342 engage against an inner edge of the second engagement holes 12 facing an upper side of the rubber cover 2.

As described above, when installing the computer mouse 100 of the present invention, the engagement fasteners of the foot pad 3 can be engaged and received in the engagement holes of the mouse main body 1, so that the foot pad 3 is firmly mounted on an outer side of the computer mouse 100. Thus, the computer mouse 100 has simpler installation and aesthetic appearance.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A computer mouse, comprising:
a mouse main body having one end formed with at least one engagement hole;
a rubber cover covered on an outer side of the mouse main body and formed with at least one opening corresponding to the engagement hole of the mouse main body; and
a foot pad having a flat foot-pad main body which has one end formed with at least one engagement member; wherein the engagement member has an elastic arm and an engagement fastener protruded from a distal end of the elastic arm; and wherein the engagement member passes through the opening of the rubber cover and then engaged and received in the engagement hole.

2. The computer mouse according to claim 1, wherein the engagement member further has an inclined guiding surface; the foot-pad main body of the foot pad has one side edge extended to form an inclined holding portion; one end of the rubber cover having the opening is further provided with a receiving recess; the foot-pad main body of the foot pad is received in the receiving recess of the rubber cover; and the holding portion of the foot pad engages against an outer side of the rubber cover.
